(19) United States
(12) Patent Application Publication
(10) Pub. No.: US 2015/0082869 A1
(43) Pub. Date: Mar. 26, 2015

(54) DETECTION METHOD AND DETECTION DEVICE FOR PIPELINES IN MACHINE-CONTROLLED LEAKAGE AND COMPLIANCE TESTS OF ANESTHETIC MACHINE

(71) Applicant: BEIJING AEONMED CO., LTD., Beijing (CN)

(72) Inventor: Yaodong Zhang, Beijing (CN)

(73) Assignee: Beijing Aeonmed Co., Ltd., Beijing (CN)

(21) Appl. No.: 14/395,977

(22) PCT Filed: Oct. 22, 2013
(86) PCT No.: PCT/CN2013/085718

§ 371 Date: Oct. 21, 2014

(30) Foreign Application Priority Data
Dec. 28, 2012 (CN) 201210587336.3

(51) Int. Cl. G01M 3/28; G08B 21/18

(52) U.S. Cl. CPC G01M 3/2815; G08B 21/187
USPC 73/49.1

(57) ABSTRACT

A detection method for pipelines in machine-controlled leakage and compliance tests of an anesthetic machine, comprising: entering a machine control leakage test and compliance test state of an anesthetic machine; piping air in an air passage outside a folding bag according to a preset flow rate, and controlling and detecting a pressure value in the air passage and the air piping time at the same time; acquiring the pressure value in the air passage and the air piping time, and judging whether a condition for the anesthetic machine to stop piping air is achieved or not according to the pressure value and the air piping time; according to the pressure value and the air piping time, obtaining a pressure change rate in the air passage in the whole air piping process; according to the pressure change rate, judging whether pipelines in leakage and compliance tests are correctly connected or not.

### TECHNICAL FIELD

The present invention relates to the field of anesthetic machines, and in particular, to a method for determining whether a respiratory pipeline in machine-controlled leakage and compliance tests of an anesthetic machine is connected correctly, and a detection device for implementing the method

### BACKGROUND

In a closed-type anesthetic machine, leakage and compliance of the anesthetic machine are tested during self-testing of the anesthetic machine when the anesthetic machine is powered on so as to make a compensation during controlled mechanical ventilation, that is, the leakage and compliance between the anesthetic machine and a respiratory pipeline are tested. To test the leakage and compliance of the anesthetic machine, the end of a respiratory pipeline of the anesthetic machine needs to be connected to an anesthetic machine test head via a Y-shaped three-way pipe. However, the end of the respiratory pipeline is generally suspended or connected to a manual bladder after the use of the anesthetic machine, this may causes that the respiratory pipeline is not connected or is incorrectly connected during the leakage and compliance tests, leading to errors in the tests.

In view of the above, there is a need for a method for determining whether a respiratory pipeline in machine-controlled leakage and compliance tests of an anesthetic machine is connected correctly. With the method of the invention, it may be learned accurately whether the pipeline connection is correct in the leakage and compliance tests, thereby avoiding test errors resulting from an incorrect pipeline connection,

### SUMMARY

In order to solve the above problem, it is an aspect of the present invention to provide a detection method for a pipeline in machine-controlled leakage and compliance tests of an anesthetic machine. By the method of the invention, it may be learned accurately whether the pipeline in the leakage and compliance tests is connected correctly, thereby avoiding test errors resulting from an incorrect connection of the pipeline.

To solve the above technical problem, the invention employs the following technical solutions.

A detection method for a pipeline in machine-controlled leakage and compliance value tests of an anesthetic machine, which at least includes:

Step S10: entering a state of machine-controlled leakage and compliance tests of an anesthetic machine;

Step S20: controlling, by a control unit, the anesthetic machine to input a gas into an external gas passage of a folding bag at a preset flow rate, controlling a pressure sensor to detect the pressure in the gas passage, and controlling timing means to detect a gas inputting duration;

Step S30: acquiring, by the control unit, the pressure in the gas passage and the gas inputting duration, and judging, by a judgment unit, whether the pressure in the gas passage reaches a preset pressure threshold and whether the gas inputting duration reaches a preset gas inputting duration threshold; and if either of the preset pressure threshold and the preset gas inputting duration threshold is reached, the control unit controlling the anesthetic machine to stop the gas inputting;

Step S40: obtaining, by a computing unit, a pressure change rate of the gas passage during the whole gas inputting process according to the pressure in the gas passage and the gas inputting duration detected in Step S20; and

Step S50: judging, by the judgment unit, whether the pipeline in the machine-controlled leakage and compliance tests of the anesthetic machine is connected correctly according to the pressure change rate.

Preferably, in Step S50:
if the pressure change rate is less than a preset pressure change rate threshold, the judgment unit judges that the pipeline for the tests is connected in error; and
if the pressure change rate is greater than or equal to a preset pressure change rate threshold, the judgment unit judges that the pipeline for the tests is connected correctly.

Preferably, Step 350 further includes:

Step S51: judging, by the judgment unit, whether the pressure change rate is equal to zero, and if the pressure change rate is equal to zero, judging by the judgment unit that the pipeline for the tests is connected in error and the end of the pipeline is suspended; otherwise, Step S52 is performed;

Step S52: judging, by the judgment unit, whether the pressure change rate is greater than zero and less than a preset pressure change rate threshold, and if the pressure change rate is greater than zero and is less than the preset pressure change rate threshold, judging by the judgment unit that the pipeline for the tests is connected in error and the end of the pipeline is connected to a manual bladder; otherwise, Step S53 is performed; and

Step S53: judging, by the judgment unit, that the pipeline for the tests is connected correctly.

Preferably, that the pipeline for the tests is connected correctly refers to that a bulkhead is connected to the end of the pipeline.

Preferably, the bulkhead is an anesthetic machine test head.

Preferably, the pressure sensor is a pressure sensor provided in the anesthetic machine.

Preferably, the pressure sensor is a pressure sensor added to the anesthetic machine additionally.

Preferably, the anesthetic machine further includes an alarming unit, which is configured to initiate an alarm when the judgment unit judges that the pipeline for the tests is connected in error.

The invention further provides a detection device for implementing any one of the above detection methods, and the detection device at least includes:
a detection unit, which at least comprises a pressure sensor for detecting pressure in a gas passage and timing means for detecting a gas inputting duration;
a control unit, which is configured for controlling the anesthetic machine to input a gas into an external gas passage of a folding bag at a preset flow rate, controlling a pressure sensor to detect the pressure in the gas passage, and controlling timing means to detect a gas inputting duration, and further controlling the anesthetic machine to stop the gas inputting when a judgment unit judges that a gas inputting stop condition is met;
a computing unit, which is configured for obtaining a pressure change rate of the gas passage according to the pressure detected by the pressure sensor and the gas inputting duration detected by the timing means; and
a judgment unit, which is configured for judging whether the gas inputting stop condition is met according to the pressure in the gas passage and the gas inputting duration, and judging whether the pipeline in the machine-controlled leakage and compliance tests of the anesthetic machine is connected correctly according to the pressure change rate.

Preferably, the detection device further includes an alarming unit, which is configured to initiate an alarm when the judgment unit judges that the pipeline for the tests is connected in error.

The beneficial effects of the present invention is described as follows. The invention utilizes a principle that: when a certain gas flow is inputted into a certain closed cavity, the pressure in the cavity will rise as the gas is inputted thereto, and the rising of the pressure is gradual depending on the size of the cavity, and particularly, the pressure rises slowly in the case of a large cavity but rises rapidly in the case of a small cavity, but the pressure may not be raised if the cavity is open. In the invention, a certain gas flow is inputted into a certain closed cavity in the leakage and compliance tests until the pressure in the gas passage reaches a target value or the gas inputting lasts for a preset time, and during the whole process, the gas passage pressure is detected by a gas passage pressure sensor, then the pressure rising speed, i.e., the pressure change rate, is calculated based on the detection by the pressure sensor to judge the connection status of the pipeline, and if the pressure change rate is equal to b 0, that is, there exists no pressure change, the pipeline is not connected; if the pressure change rate is low and the pressure rises very slowly, the pipeline is connected to a manual bladder; otherwise, it may be learned that the pipeline is connected correctly. By employing this method of the invention, it may be accurately learned whether the pipeline connection is correct during the leakage and compliance tests, thereby avoiding test errors resulting from an incorrect pipeline connection. When the pressure in the pipeline is detected by the existing sensor of the anesthetic machine, no additional detection device is added for detecting whether the pipeline is connected correctly, thus the cost may be saved and the operation process is simple.

### BRIEF DESCRIPTION OF THE DRAWINGS

FIG. 1 is a structural representation showing that the end of a pipeline in an anesthetic machine according to the invention is suspended;

FIG. 2 is a structural representation showing that the end of the pipeline in an anesthetic machine according to the invention is connected to a manual bladder;

FIG. 3 is a structural representation showing that the end of the pipeline in an anesthetic machine according to the invention is connected to an anesthetic machine test head; and

FIG. 4 is a flow chart of a detection method for a pipeline in machine-controlled leakage and compliance tests of an anesthetic machine according to the invention,

### IN THE DRAWINGS

1: Driving gas inlet pipe
2: Fresh gas inlet pipe
3: Pressure sensor
4: Y-Shaped three-way pipe
5: Nashville tank
6: Folding bag
7: Manual bladder
8: Anesthetic machine test head

### DETAILED DESCRIPTION OF THE EMBODIMENTS

The technical solutions of the invention will be further illustrated below by specific embodiments.

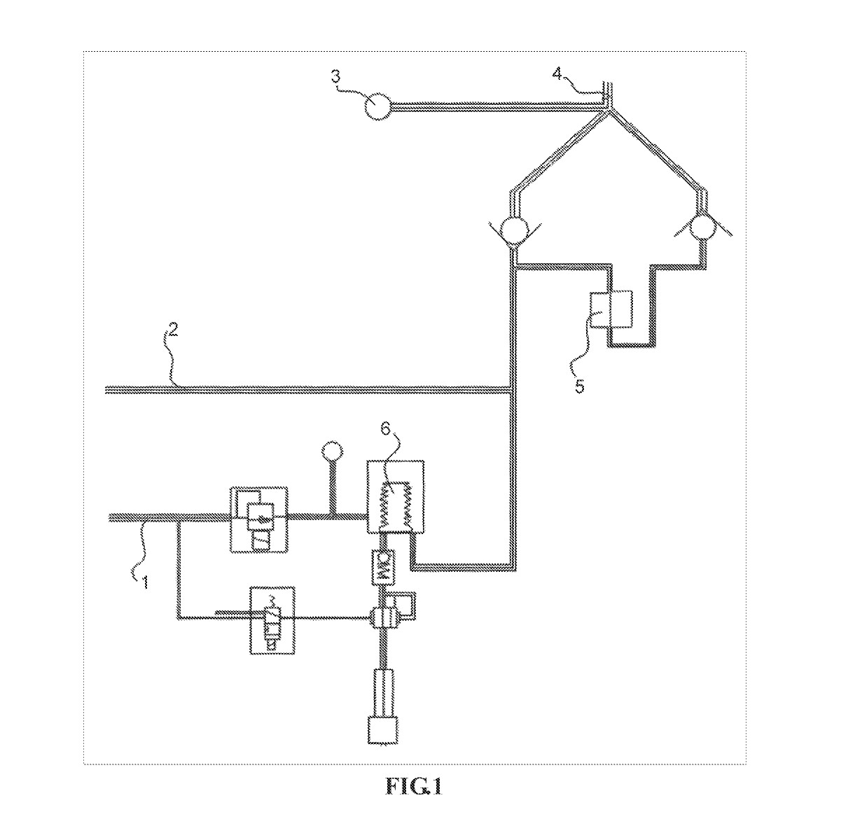

As shown in FIGS. 1 to 3, the internal connection structure of an anesthetic machine is such that; a driving gas inlet pipe 1 is connected with an external gas passage of a folding bag 6, and a fresh gas inlet pipe 2 is connected with the folding bag 6, so that a fresh gas for pulmonary respiration is inputted into the folding bag 6 via the fresh gas inlet pipe 2, meanwhile a driving gas is inputted into the external gas passage of the folding bag 6 via the driving gas inlet pipe 1. Specifically, the anesthetic machine works in such away that: the driving gas in the external gas passage of the folding bag 6 drives the fresh gas in the folding bag 6 to flow into a lung, and the exhaust gas from the lung enters a Nashville tank 5 containing a substance for absorbing the exhaust gas, so that the gas from the lung passes through the Nashville tank 5, flows into the folding bag 6 to be mixed with the fresh gas, and thus flows into the lung circularly. The final exhaust gas flows out from a pipeline at the lower end of the folding bag 6 to an exhaust gas pipe for discharging.

Before the use of the anesthetic machine, machine-controlled leakage and compliance tests need to be performed on the anesthetic machine. For the specific tests, a respiratory pipeline is first connected to a bulkhead via a Y-shaped three-way pipe 4. In this embodiment, an anesthetic machine test head 8 may be used as the bulkhead. Subsequently, a certain gas flow is inputted into the folding bag 6 of the anesthetic machine to increase the pressure in the gas passage of the anesthetic machine to a target value, then the inputting of the gas is stopped for a certain period of time, and the pressure value during this period of time is recorded, and then values of the leakage and the compliance are calculated.

For the purpose of the leakage and compliance tests of an anesthetic machine, it is required to connect the respiratory pipeline to an anesthetic machine test head 8 via a Y-shaped three-way pipe 4. However, in the practical test process, the end of the respiratory pipeline is typically suspended or connected to a manual bladder 7 after the use of the anesthetic machine, this may causes that the respiratory pipeline is not connected or is incorrectly connected during the leakage and compliance tests, leading to errors in the test. Therefore, in the leakage and compliance tests of an anesthetic machine, there is a need for guaranteeing that the Y-shaped three-way pipe 4 at the end of the respiratory pipeline is connected to the anesthetic machine test head 8 so as to guarantee a correct connection, thereby avoiding test errors resulting from an incorrect pipeline connection.

In view of the above problem, before the leakage and compliance tests of an anesthetic machine in the invention, detection on whether the Y-shaped three-way pipe 4 at the end of the respiratory pipeline is connected to the anesthetic machine test head 8 is carried out to guarantee a correct connection, thereby avoiding test errors resulting from an incorrect pipeline connection.

When a certain gas flow is inputted into a certain closed cavity, the pressure in the cavity will rise as the gas is inputted thereto, and the rising of the pressure is gradual depending on the size of the cavity, and particularly, the pressure rises slowly in the case of a large cavity but rises rapidly in the case of a small cavity, but the pressure may not be raised if the cavity is open.

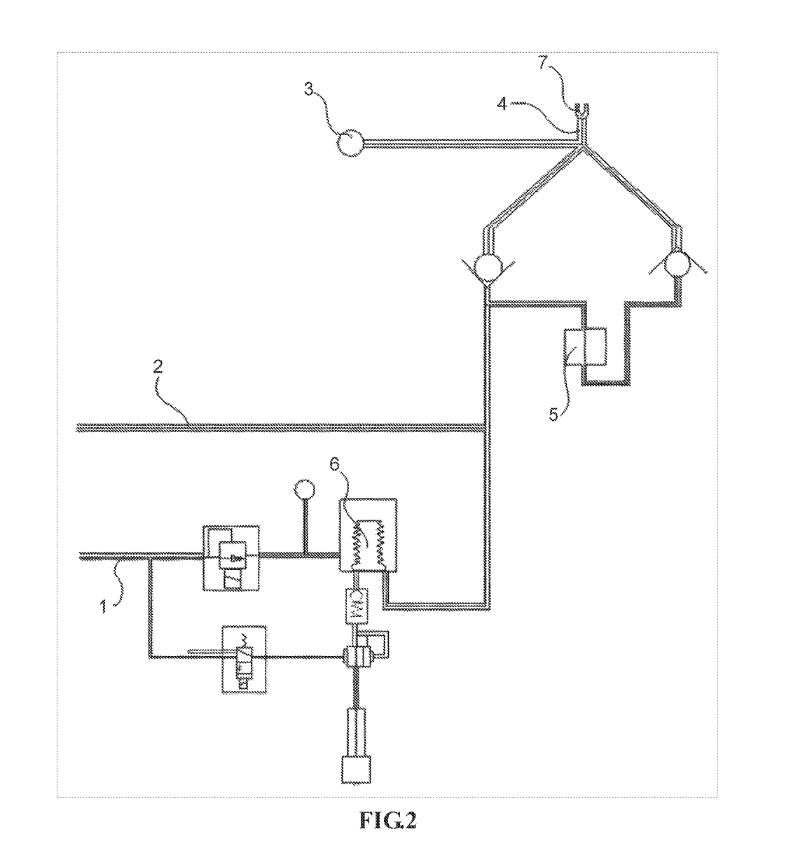

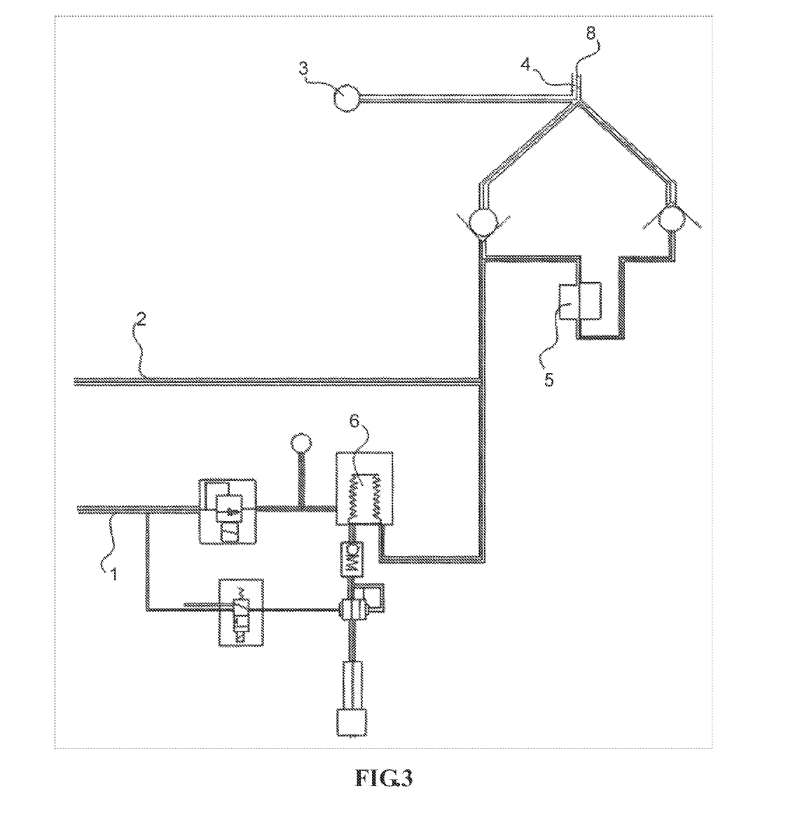

Therefore, when a certain gas flow is inputted into the folding bag 6, the pressure in the gas passage of the folding bag 6 will rise gradually at a rising speed (i.e., a pressure change rate), which depends on the connection of the subsequent respiratory pipeline. if the subsequent respiratory pipeline is not connected, as shown in FIG. 1, that is, the respiratory pipeline is directly suspended, the pressure in the gas passage will not change, that is, the pressure is not increased, thus the pressure change rate is zero. As shown in FIG. 2, the respiratory pipeline is connected to a manual bladder 7 which generally has a volume of 2L or 3L, the pressure will rise slowly at a relatively low pressure change rate when a gas is inputted into the folding bag 6. Only when the respiratory pipeline is connected to the anesthetic machine test head 8, as shown in FIG. 3, can the pressure rise rapidly at a high pressure change rate. Therefore, through detecting the gas passage pressure by a pressure sensor 4, and calculating the pressure change rate, it is possible to determine whether the respiratory pipeline is connected correctly according to the pressure change rate.

Therefore, in the invention, whether the respiratory pipeline is connected correctly is mainly detected in a process of inputting a certain gas flow into the folding bag 6 to increase the pressure in the gas passage to a target value.

In the specific testing method of the invention, the detection on the respiratory pipeline is added in the leakage and compliance tests. Such detection does not require for adding a detection device to the existing anesthetic machine; instead, an existing pressure sensor 4 of the anesthetic machine, which is configured for measuring the pressure in the gas passage, is employed. The connection status of the respiratory pipeline may be determined by detecting the pressure rising speed, i.e., the pressure change rate, using the pressure sensor 4. If the pressure change rate is equal to 0, that is, there exists no pressure change, it is indicated that the respiratory pipeline is not connected; if the pressure change rate is small and the pressure rises very slowly, it is indicated that the respiratory pipeline is connected to the manual bladder 7; otherwise, it is indicated that a bulkhead is connected to the end of the respiratory pipeline. In this embodiment, the bulkhead is the anesthetic machine test head 8.

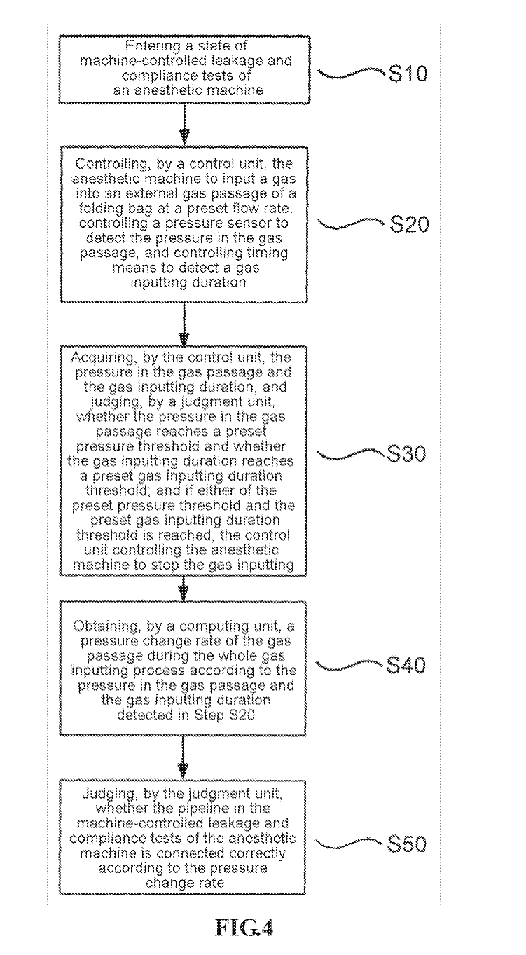

FIG. 4 is a flow chart showing a specific embodiment of a method for determining whether a pipeline is connected correctly according to the invention. As shown in FIG. 4, such a method for determining whether a pipeline of an anesthetic machine is connected correctly includes the following steps.

Step S10: entering a state of machine-controlled leakage and compliance tests of an anesthetic machine.

Step S20: controlling, by a control unit, the anesthetic machine to input a gas into an external gas passage of a folding bag at a preset flow rate, controlling a pressure sensor to detect the pressure in the gas passage, and controlling timing means to detect a gas inputting duration.

Step S30: acquiring, by the control unit, the pressure in the gas passage and the gas inputting duration, and judging, by a judgment unit, whether the pressure in the gas passage reaches a preset pressure threshold and whether the gas inputting duration reaches a preset gas inputting duration threshold; and if either of the preset pressure threshold and the preset gas inputting duration threshold is reached, controlling, by the control unit, the anesthetic machine to stop the gas inputting.

In this embodiment, the preset gas inputting duration threshold for the gas inputting varies with different anesthetic machine models and differences of parts of the anesthetic machines, and hence has a variable value. Therefore, the preset gas inputting duration threshold may change with different models of anesthetic machines or with changes of a certain part of the anesthetic machine.

Step S40: obtaining, by a computing unit, a pressure change rate of the gas passage during the whole gas inputting process according to the pressure in the gas passage and the gas inputting duration detected in Step S20.

Step S50: judging, by the judgment unit, whether the respiratory pipeline in the machine-controlled leakage and compliance tests of the anesthetic machine is connected correctly according to the pressure change rate.

Specifically, the above Step S50 includes:

Step S51: judging, by the judgment unit, whether the pressure change rate is equal to zero, and if the pressure change rate is equal to zero, judging by the judgment unit that the respiratory pipeline for the tests is connected in error and the end of the pipeline is suspended; otherwise, Step S52 is performed;

Step S52: judging, by the judgment unit, whether the pressure change rate is greater than zero and less than a preset pressure change rate threshold, and if the pressure change rate is greater than zero and is less than the preset pressure change rate threshold, judging by the judgment unit that the respiratory pipeline for the tests is connected in error and the end of the pipeline is connected to a manual bladder; otherwise, Step S53 is performed; and

Step S53: judging, by the judgment unit, that the respiratory pipeline for the tests is connected correctly, that is, a bulkhead is connected to the end of the pipeline for the tests.

Preferably, in this embodiment, the bulkhead is the anesthetic machine test head.

In this embodiment, the pressure sensor is preferably a pressure sensor provided in the anesthetic machine itself. Of course, it may be understood by one skilled in the art that, a pressure sensor added to the anesthetic machine additionally may also be used. However, when the pressure sensor provided in the anesthetic machine is used for the tests, not only the cost may be saved, but also the whole test process is simple, convenient and easy to implement.

Preferably, the anesthetic machine is further provided with an alarming unit, which is configured to initiate an alarm when the judgment unit judges that the pipeline for the tests is connected in error.

The invention further provides an embodiment of a detection device for implementing the above method for detecting a pipeline in machine-controlled leakage and compliance tests of an anesthetic machine. In this embodiment, the detection device at least includes:
a detection unit, which at least includes a pressure sensor for detecting pressure in a gas passage and timing means for detecting a gas inputting duration;
a control unit, which is configured for controlling the anesthetic machine to input a gas into an external gas passage of a folding bag at a preset flow rate, controlling a pressure sensor to detect the pressure in the gas passage, and controlling timing means to detect a gas inputting duration, and further controlling the anesthetic machine to stop the gas inputting when a judgment unit judges that a gas inputting stop condition is met;
a computing unit, which is configured for obtaining a pressure change rate of the gas passage according to the pressure detected by the pressure sensor and the gas inputting duration detected by the timing means; and
a judgment unit, which is configured for judging whether the gas inputting stop condition is met according to the pressure in the gas passage and the gas inputting duration, and judging whether the respiratory pipeline in the machine-controlled leakage and compliance tests of the anesthetic machine is connected correctly according to the pressure change rate.

Preferably, the detection device further includes an alarming unit, which is configured to initiate an alarm when the judgment unit judges that the pipeline for the tests is connected in error, so that an operator may terminate the testing process, thereby an error test result and the harmful consequence resulting from the error test result may be avoided.

The technical principles of the invention have been described above in conjunction with specific embodiments. These descriptions are only used for explaining the principles of the invention, rather than limiting the protection scope of the invention in any way. Other specific implementations may be made by one skilled in the art based on the explanation herein without creative work, and all these implementations will fall into the protection scope of the invention.

1. A detection method for a pipeline in machine-controlled leakage and compliance tests of an anesthetic machine, comprising:
Step S10: entering a state of machine-controlled leakage and compliance tests of an anesthetic machine;
Step S20: controlling, by a control unit, the anesthetic machine to input a gas into an external gas passage of a folding bag at a preset flow rate, controlling a pressure sensor to detect the pressure in the gas passage, and controlling timing means to detect a gas inputting duration;
Step S30: acquiring, by the control unit, the pressure in the gas passage and the gas inputting duration, and judging, by a judgment unit, whether the pressure in the gas passage reaches a preset pressure threshold and whether the gas inputting duration reaches a preset gas inputting duration threshold; and if either of the preset pressure threshold and the preset gas inputting duration threshold is reached, the control unit controlling the anesthetic machine to stop the gas inputting;
Step S40: obtaining, by a computing unit, a pressure change rate of the gas passage during the whole gas inputting process according to the pressure in the gas passage and the gas inputting duration detected in Step S20; and
Step S50: judging, by the judgment unit, whether the pipeline in the machine-controlled leakage and compliance tests of the anesthetic machine is connected correctly according to the pressure change rate.

2. The detection method according to claim 1, wherein, in Step S50:
if the pressure change rate is less than a preset pressure change rate threshold, the judgment unit judges that the pipeline for the tests is connected in error; and
if the pressure change rate is greater than or equal to a preset pressure change rate threshold, the judgment unit judges that the pipeline for the tests is connected correctly.

3. The detection method according to claim 2, wherein, Step S50 further comprises:
Step S51: judging, by the judgment unit, whether the pressure change rate is equal to zero, and if the pressure change rate is equal to zero, judging by the judgment unit that the pipeline for the tests is connected in error and the end of the pipeline is suspended; otherwise, Step S52 is performed;
Step S52: judging, by the judgment unit, whether the pressure change rate is greater than zero and less than a preset pressure change rate threshold, and if the pressure change rate is greater than zero and is less than the preset pressure change rate threshold, judging by the judgment unit that the pipeline for the tests is connected in error and the end of the pipeline is connected to a manual bladder; otherwise, Step S53 is performed; and
Step S53: judging, by the judgment unit, that the pipeline for the tests is connected correctly.

4. The detection method according to claim 2, wherein, that the pipeline for the tests is connected correctly refers to that a bulkhead is connected to the end of the pipeline.

5. The detection method according to claim 4, wherein, the bulkhead is an anesthetic machine test head.

6. The detection method according to claim 1, wherein, the pressure sensor in Step S20 is a pressure sensor provided in the anesthetic machine.

7. The detection method according to claim 1, wherein, the pressure sensor in Step S20 is a pressure sensor added to the anesthetic machine additionally.

8. The detection method according to claim 1, wherein, the anesthetic machine further comprises an alarming unit, which is configured to initiate an alarm when the judgment unit judges that the pipeline for the tests is connected in error.

9. A detection device for implementing a detection method according to claim 1, wherein, the detection device at least comprises:
a detection unit, which at least comprises a pressure sensor for detecting pressure in a gas passage and timing means for detecting a gas inputting duration;
a control unit, which is configured for controlling the anesthetic machine to input a gas into an external gas passage of a folding bag at a preset flow rate, controlling a pressure sensor to detect the pressure in the gas passage, and controlling timing means to detect a gas inputting duration, and further controlling the anesthetic machine to stop the gas inputting when a judgment unit judges that a gas inputting stop condition is met;
a computing unit, which is configured for obtaining a pressure change rate of the gas passage according to the pressure detected by the pressure sensor and the gas inputting duration detected by the timing means; and
a judgment unit, which is configured for judging whether the gas inputting stop condition is met according to the pressure in the gas passage and the gas inputting duration, and judging whether the pipeline in the machine-controlled leakage and compliance tests of the anesthetic machine is connected correctly according to the pressure change rate.

10. The detection device according to claim 9, further comprising an alarming unit, which is configured to initiate an alarm when the judgment unit judges that the pipeline for the tests is connected in error.
